(19) United States
(12) Patent Application Publication
(10) Pub. No.: US 2003/0061748 A1
(43) Pub. Date: Apr. 3, 2003

(54) Light an address

(76) Inventor: Majid Ghaznavi, Dallas, TX (US)

Correspondence Address: MAJID GHAZNAVI, P.O. BOX 835411, RICHARDSON, TX, 75080, US

(21) Appl. No.: 09/967,824

(22) Filed: Oct. 1, 2001

(51) Int. Cl. G09F 13/04

(52) U.S. Cl. 40/576

(57) ABSTRACT

This new product “LIGHT AN ADDRESS” is of nonexistence inthe maeketplace, and will ease, search for home, and business address numbers at night, and dark areas.

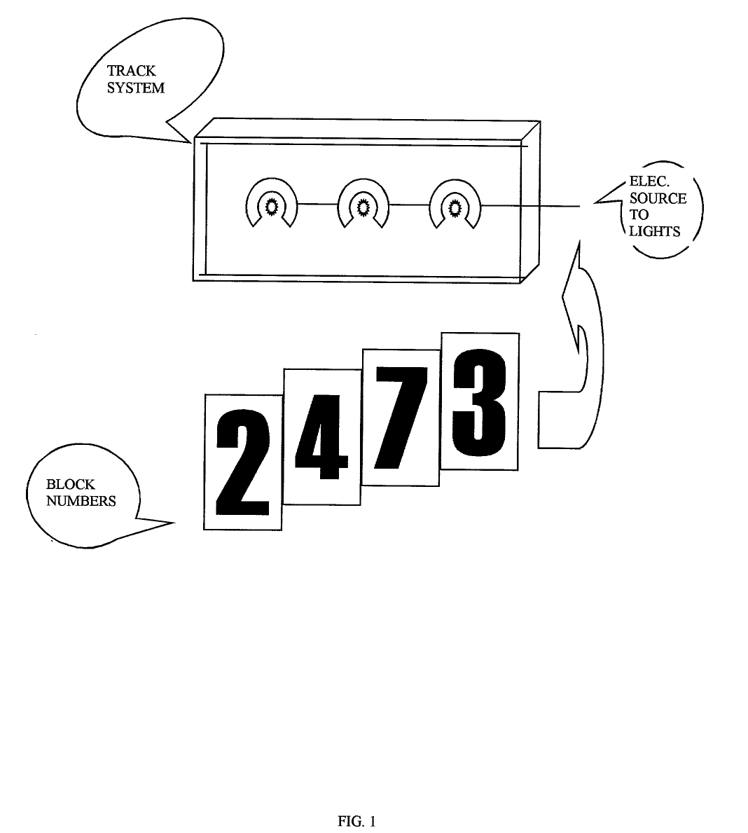

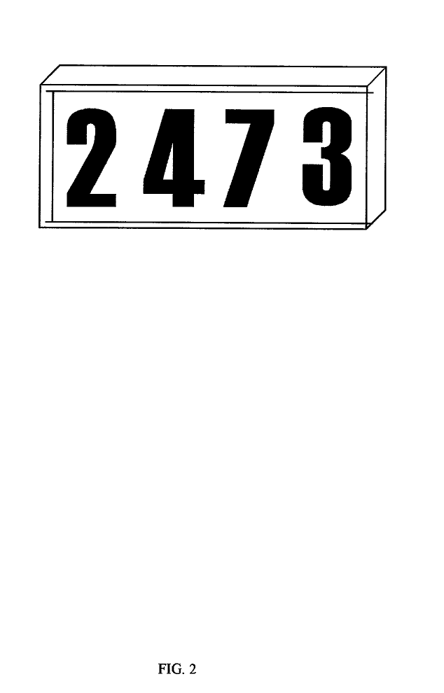

Customary address numbers are unreadable, and hard to find specially in bad whether, and dark streets.

### LIGHT AN ADDRESS

Up till now residential street address have been very hard to see, and frustrating to find because of dark, and invisibility, specially to the older people. The problem starts with either the location of the address number, the size, or the color being too close to the background walls. Adding background light, and more visible colors to the numbers will increase the visibility, and the ease of search!

### HOW THE LIGHT AN ADDRESS WORKS

Light an address is comprised of two important components:

1—Back Light Box

Back light box is made of a whether proof material such as plastic, or aluminum. It has the proper brackets for a light source, and low voltage light for energy saving purposes.

2—Number System

Due to different home/business address numbers, the box will provide a track system for different numbers to be installed on the box.

Numbers are made from colored plastic material and can be inserted in the provided tracks on the top, and the bottom of the box, and will be sold separately from the box. This gives the buyer the selection of their address number to be posted.

3—The Electric Source

Will be able to feed through witing form the existing outside light wiring, or can have a solar battery source to avoid additional wiring.

1. I Majid Ghaznavi claim as my invention is a product that will provide an easier, and convenient way to search for address numbers, both homes or business.
The traditional curb, or front door addressing system is extremely difficult to locate specially in bad whether, and at night with poor street lighting.
This product can reduce trafic slow down, or suden stops due to confusing and hard to find address numbers.
